(19) United States
(12) Patent Application Publication
(10) Pub. No.: US 2009/0309593 A1
(43) Pub. Date: Dec. 17, 2009

(54) MICELLE SOLUTION TO REDUCE DIELECTRIC RESONANCE EFFECTS IN MRI PHANTOMS

(75) Inventor: Phillip Edward Steen, Delafield, WI (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/375,415

(22) PCT Filed: Jul. 27, 2007
(86) PCT No.: PCT/US07/74574

§ 371 Date: Jan. 28, 2009

Related U.S. Application Data
(60) Provisional application No. 60/833,958, filed on Jul. 28, 2006.

(51) Int. Cl. G01V 3/00; H01F 1/44

(52) U.S. Cl. 324/307; 252/62.51 R

(57) ABSTRACT

A micelle solution for use in MRI phantoms (10) comprises a non-hydrogen bearing oil or oil-like fluid (26), a surfactant (29) and water (28) mixed to form a micelle solution and held in a non-ferromagnetic, non-conductive container (12) sized to be received by the MRI machine.

The present invention relates to magnetic resonance imaging (MRI) systems, and more particularly, relates to phantoms used to test the performance of MRI systems.

Magnetic resonance imaging is used to generate medical diagnostic images by measuring faint radio frequency (RF) signals (magnetic resonance) emitted by atomic nuclei in tissue (for example, water protons) after radio frequency stimulation of the tissue in the presence of a strong magnetic field.

The location of the precessing protons is made possible by the application of orthogonal magnetic gradient fields which serve to “encode” the spins according to frequency, phase, and/or slice. The combination of the radiofrequency stimulation and the applied gradient fields is termed a pulse sequence.

The acquired signal from the spins (termed a nuclear magnetic resonance (NMR) signal) provides data in “k-space”, a mathematical construction in the frequency domain. A two-dimensional Fourier transform of the k-space data produces the actual image. It will be understood, therefore, that the k-space data does not represent the image itself, but represents the spectral components of the image with the center of k-space representing low frequency spatial components of the image, and the outer portions of k-space representing the high frequency spatial components of the image.

The impressing of spatial location information onto the spins of the NMR signal by the applied magnetic gradients makes it extremely important that all applied magnetic fields (including the polarizing magnetic field B₀ and the gradient magnetic fields Gₓ, G_{y}, and G_{z}) be well characterized. For this reason, and particularly for the B₀ field, it is well known to incorporate shimming coils into the design of a magnetic resonance imaging machine which serve to correct for inhomogeneities in the B₀ field through the application of one or more superimposed shimming fields.

A number of techniques are known by which to measure inhomogeneities of the magnetic field and thus to calculate the currents needed for the shimming coils. For example, special pulse sequences detecting phase differences in the MRI measurements of a homogenous phantom, for example, a tank of water paramagnetic ion to shorten T₁ and T₂ and sodium chloride to provide the desired loading, may be used to deduce variations in the magnetic field of the MRI system.

One problem in creating phantoms is that water has a high dielectric constant that shortens the wavelengths of radio frequency (RF) energy through the phantom, leading to standing waves and other resonance effects that degrade uniformity of the image at magnetic field strengths greater than 1.5 Tesla.

One solution to this problem is the introduction of low dielectric constant material (such as decane) that essentially “dilutes” the water. Unfortunately, this approach, although correcting for standing waves and other resonance effects, does not provide the desired degree of electrical loading due to the relatively low conductivity of the solution. In addition, decane is a highly flammable material, which results in potentially hazardous conditions during the production and use of the solution. Furthermore, decane diffuses readily into most plastics (from which the phantom housing would be constructed). Finally, decane and water resonate at different frequencies which can create imaging problems with some pulse sequences, particularly in the presence of B₀ inhomogeneities.

Alternatively, phantoms prepared with oil rather than water have been utilized for testing magnetic field strengths of 3 Tesla. The use of oil effectively eliminates the resultant shading created by the dielectric resonance effects in water phantoms. However, oil phantoms do not effectively load the coils so performance assessment of the coil with images is sensitive to effects of normal manufacturing tolerances.

The present inventor has recognized that the loading provided by a mixture of low dielectric constant material and water may be increased by promoting the formation of micelles in which islands of the low dielectric constant material are wholly surrounded by conductive water, providing an eddy current path for loading while reducing the average dielectric constant of the phantom. A non-hydrogen bearing oil or oil-like material may be used for the low dielectric material and a surfactant used to create the micelles. The resulting phantom solves the dielectric resonance problem while maintaining the ability to load the coil due to the presence of conductive pathways through the water.

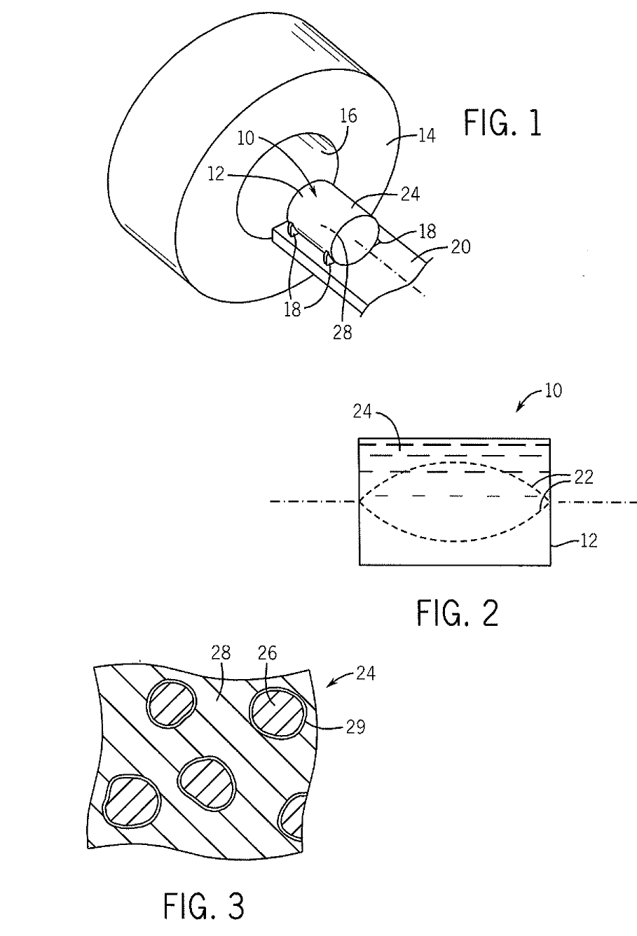

FIG. 1 is a perspective side view of the phantom of the present invention;

FIG. 2 is a cross-section of the phantom of FIG. 1 showing the presence of standing waves therein;

FIG. 3 is a schematic diagram of the micelle solution of the present invention.

Referring now to the drawings and initially to FIG. 1, in one embodiment, the phantom 10 of the present invention may comprise a cylindrical container 12, having an outer wall constructed of a non-ferrous, electrically insulating material. The container 12 may include a stand 18 or other such support structures for supporting and stabilizing the container 12 on a table 20 of an MRI machine, the latter sized to support a patient thereon and to fit inside the bore 16 of a standard MRI magnet 14. The container 12 alternatively could be anatomically shaped and sized to simulate a part or the entirety of the human body.

Turning now to FIG. 2, the container 12 when filled with phantom material 24 may promote a standing waves 22 along a given dimension of the container 12 when the speed of electromagnetic waves passing through the phantom material 24 is such that one half of the wavelength electromagnetic waves (or an integral multiple thereof) matches the given dimension. These standing waves are undesirable because they promote an inhomogenous excitation of the hydrogen protons in the phantom material 24 such as interferes with use of the phantom 10. Standing waves 22 of this type can be a problem for high field strengths magnets greater than 1.5 Tesla using conventional water solutions.

Turning now to FIG. 3, the present invention provides a phantom material 24 comprised of micelle solution being a mixture of a non-hydrogen bearing oil or oil-like fluid 26, a surfactant 29, and water 28. The non-hydrogen bearing oil or oil-like fluid can be a perflurocarbon compound solution and in a preferred embodiment of the present invention, has a density similar to or less than water.

As is understood in the art, surfactants 29 are generally strongly hydrophilic (attracted to polar molecules such as water) on one end and strongly hydrophobic (attracted to non-polar molecules such as hydrocarbons) and in the present invention form a film separating the water 28 and non-hydrogen bearing oil 26 as will be described. In the present invention the surfactant 29 could be sodium octanoate (SOC), sodium decanoate (SDEC), sodium dodecanoate (DODEC), sodium dodecyl sulfate (SDS), sodium succinate or any other surfactant that can be used to create a micelle solution.

The water 28 is preferably doped with a paramagnetic ion and sodium chloride as in conventional phantoms, but the large quantity of non-hydrogen bearing oil 26 significantly reduces the total quantity of water, thereby reducing the dielectric constant of the overall phantom material 24 and thus reducing standing waves or dielectric resonance artifacts. Depending on the ratio of water 28 to oil or oil-like fluid 26, the solution could take on the form of a micelle or reverse micelle solution. In a micelle solution, the surfactant molecules tend to encapsulate the oil in tiny spherical globules in a surrounding matrix of water. In a reverse micelle solution, the surfactant tends to encapsulate the water in tiny spherical globules in the surrounding matrix of oil or oil-like fluid. The main difference between a reverse micelle and micelle phantom is that micelle phantoms have conductive pathways (through the water) that provide increased loading for the coil being tested. As such, the use of a micelle, rather than reverse micelle is preferred.

It is specifically intended that the present invention not be limited to the embodiments and illustrations contained herein and the claims should be understood to include modified forms of those embodiments including portions of the embodiments and combinations of elements of different embodiments as come within the scope of the following claims.

1. A phantom for use with a MRI machine comprising:
a housing comprising a non-ferromagnetic and non-conductive material, the housing including a means for stabilizing the housing in a MRI machine, wherein the housing has a volume approximating a human within a field of view of the MRI machine, the housing further containing a solution comprising
water,
a surfactant,
a non-hydrogen bearing fluid,
wherein the water, surfactant, and non-hydrogen bearing fluid are compounded in a micelle solution wherein the non-hydrogen bearing fluid is encapsulated by the surfactant in a matrix of water.

2. The phantom of claim 1 wherein the water is doped with a paramagnetic ion.

3. The phantom of claim 2 wherein the water is additionally doped with sodium chloride.

4. The phantom of claim 1 wherein the surfactant comprises one of: sodium octanoate (SOC), sodium decanoate (SDEC), sodium dodecanoate (DODEC), sodium succinate and sodium dodecyl sulfate (SDS).

5. The phantom of claim 1 wherein the phantom contains a proportion of the non-hydrogen bearing fluid thereby reducing a relative volume of the water in the solution, thereby reducing a dielectric constant of the solution.

6. The phantom of claim 1 wherein the non-hydrogen bearing fluid comprises an oil.

7. The phantom of claim 6 wherein the oil is perfluorocarbon oil.

8. The phantom of claim 1 wherein standing waves are not generated when field strengths greater than 1.5 Tesla are applied to the phantom.

9. The phantom of claim 8 wherein standing waves are not generated when field strengths greater than 3 Tesla are applied to the phantom.

10. The phantom of claim 1 wherein the solution is a reverse micelle solution wherein the water is encapsulated by the surfactant in a matrix of oil.

11. The phantom of claim 1 wherein the solution is configured to substantially reduce standing waves and resonance effects when a RF signal is applied to the solution.

12. A solution for use in an MRI phantom comprising:
a non-hydrogen bearing fluid;
a surfactant;
water, wherein the water is doped with a paramagnetic ion and sodium chloride; and wherein a ratio of the non-hydrogen bearing fluid and the surfactant to the water is such that a dielectric constant of the solution is less than that of the water.

13. The solution of claim 12 wherein non-hydrogen bearing fluid is perfluorocarbon oil.

14. The solution of claim 12 wherein the non-hydrogen bearing fluid has a density substantially equal to that of water.

15. The solution of claim 12 wherein the non-hydrogen bearing fluid has a density substantially less than that of water.

16. The solution of claim 12 wherein the surfactant is substantially hydrophilic on one end thereof and substantially hydrophobic on an opposite end thereof.

17. The phantom of claim 16 wherein the surfactant comprises one of: sodium octanoate (SOC), sodium decanoate (SDEC), sodium dodecanoate (DODEC), sodium succinate and sodium dodecyl sulfate (SDS).

18. The solution of claim 12 wherein the ratio of the water to the non-hydrogen bearing fluid is such that the solution comprises a micelle solution.

19. The solution of claim 12 wherein the ratio of the water to the non-hydrogen bearing fluid is such that the solution comprises a reverse micelle solution.
